(19) United States
(12) Patent Application Publication
(10) Pub. No.: US 2011/0140957 A1
(43) Pub. Date: Jun. 16, 2011

(54) METHODS FOR REDUCING GLOBAL POSITIONING SYSTEM ERRORS IN PORTABLE ELECTRONIC DEVICES

(76) Inventors: Ronald William Dimpflmaier, Los Gatos, CA (US); William Jean Noellert, Mountain View, CA (US)

(21) Appl. No.: 12/638,850

(22) Filed: Dec. 15, 2009

(51) Int. Cl. G01S 19/14; G01S 19/42; G01S 19/13; H04N 5/76

(52) U.S. Cl. 342/357.25; 342/357.52; 342/357.51; 348/231.3; 348/E05.024

(57) ABSTRACT

A portable user device may provide Global Positioning System (GPS) services. The device may include a GPS unit. The GPS unit may provide accurate information about the current position, direction, and speed of the device. A user may use the device to perform tasks. Certain tasks may generate excess heat that causes the GPS unit to produce erroneous data. Methods can be used to acquire accurate data samples that are associated with the respective tasks. The device may wait for a period of time after the start of a task before acquiring a GPS sample. The device may also buffer GPS samples and to take the most recent buffered sample as the acquired GPS sample. The device may take a GPS sample immediately after the start of a task, before error starts to arise. GPS samples may be buffered and used to calculate an extrapolated data sample value.

### BACKGROUND

This invention relates to portable electronic devices, and more particularly, to portable electronic devices that have Global Positioning System (GPS) capabilities.

Electronic devices such as portable electronic devices may have Global Positioning System (GPS) capabilities. Electronic device with GPS capabilities may provide reliable positioning, navigation, and timing services. The Global Positioning System includes satellites that orbit the Earth, Earth-based control and monitoring stations, and GPS receivers that are located within the electronic devices. GPS services may be provided on a continuous basis anywhere that is within range of the orbiting satellites.

A GPS unit may be located within the housing of a user's portable electronic device. The GPS unit may sometimes be referred to as a GPS receiver. The GPS unit determines the current position (location) of the portable electronic device. During operation, the GPS unit may receive data streams from GPS satellites orbiting the Earth.

Using a local clock, the GPS unit can analyze each data stream to make a transit time and distance estimation. A method known as geometric trilateration may be used to determine the location of the GPS unit by analyzing the estimated distances of each of the satellites to the GPS unit.

The accuracy of location measurements made using the GPS unit is influenced by the quality of the local clock. The local clock is typically implemented using a crystal oscillator. If the output of the oscillator exhibits errors, the GPS location that is provided by the GPS unit will also exhibit errors.

Some GPS units are housed in dedicated handheld devices. Other GPS units are used in more complex devices such as cellular telephones. Devices such as these may have components whose operations can adversely affect GPS accuracy.

As an example, a device may include a camera that allows the user to acquire images. A flash unit in the device may be triggered to produce a flash of light when the camera is being used to acquire an image. If desired, the image may be location tagged (e.g., the image may be associated with the geographic position of the user device at the moment the image was acquired). If care is not taken, heat from the flash may adversely affect the accuracy of the oscillator in the GPS unit, thereby resulting in GPS location errors. A GPS location measurement that is made when acquiring an image may therefore be inaccurate.

It would therefore be desirable to be able to provide ways of avoiding GPS errors of this type.

### SUMMARY

An electronic device such as a portable user device may provide Global Positioning System (GPS) services. The user device may include a GPS unit, storage and processing circuitry, a camera, a flash unit, etc. The GPS unit may provide information such as the current position, direction, and speed of the user device.

In addition to providing the GPS services, the user device may be used perform various tasks. For example, the user device may be used to take pictures, make telephone calls, browse the Internet, run gaming applications, etc. Performing certain tasks may produce heat that momentarily raises the temperature of the GPS unit.

If the GPS unit suffers from rapid changes in temperature (e.g., if a high temperature gradient produced on a printed circuit board on which GPS circuitry is mounted), the GPS unit may produce erroneous data. This type of situation can be avoided by controlling the time at which GPS measurements are made relative to the time at which heat-producing tasks are performed.

Tasks that cause sudden changes in temperature (i.e., a high rate of change in temperature) may be categorized as having high temperature-gradient-inducing activity levels. A time period during which a high activity level application is running may be referred to as an error interval. The GPS unit may not provide data with a desired level of accuracy during error intervals.

It may be desirable for a GPS unit to produce GPS data in association with a high activity level task. For example, a user may want to take a picture and may want to tag the picture with an associated location tag. The user's portable electronic device, however, may generate a flash that creates excess heat during this process. This heat may cause the GPS unit to produce inaccurate results at the moment the picture is taken. Portable electronic devices may therefore be configured to take GPS readings at times that are not adversely affected by temporary heat producing events.

One technique that a device may use involves waiting for a period of time after a task has begun before acquiring an associated GPS data sample. This technique works well when the activity level in the device returns to an acceptably low level (e.g., a level that causes relatively no GPS error) at the expiration of a given waiting period. Once the waiting period expires, the associated GPS data can be immediately acquired.

Another technique that may be used involves storing (buffering) GPS samples during normal operations (e.g., at regular intervals when the GPS unit is functioning properly). When a user starts a high activity level task that requires an associated GPS data sample, the most recent buffered sample can be used. In contrast to the previous technique, this technique involves acquiring the GPS sample that precedes the task rather than acquiring the GPS sample that comes after the task.

If desired, the associated GPS data sample may be acquired immediately after a user initiates a task but before the temperature-gradient-inducing activity level starts to increase. Often, the initiation of a certain task may not in itself generate excess heat but the initiation may trigger another event that directly generates excess heat. For example, pressing a shutter button to take a picture causes the flash unit to produce a heat-generating flash. GPS error can be avoided by taking a GPS reading after the button has been pressed and before the flash has been triggered. This type of approach may work well provided that the associated GPS data sample is stored prior to the triggered heat-generating event.

The techniques described above may be useful for a user device that is not moving or that is moving significantly. One way to acquire an accurate associated GPS data sample for a moving user device involves buffering the GPS samples at regular time intervals during normal operations. When a high activity level task is initiated, the storage and processing circuitry may calculate an extrapolated data sample based on the buffered samples. The extrapolated data sample may be used in place of a sample that would otherwise have been acquired during a heat-producing event. Extrapolating GPS sample values in this way may help avoid heat-induced inaccuracies in moving devices.

If desired, the user device may be used to implement a navigation service. The navigation service may display a map with a moving cursor that constantly updates the current location of the user device. A user may want to start an application or perform another task that interrupts the GPS navigation service. In response, storage and processing circuitry in the user device may acquire an out-of-order sample to record the most recent location of the user device before actually launching the interrupting task. The operation of the GPS unit may be temporarily suspended during the duration of the task. Once the task ends, the GPS unit may resume normal operation. The GPS unit may use the out-of-order sample as the current location of the user device immediately after the termination of the task. The actual location of the user device will be updated once the storage and processing circuitry samples the next GPS data point provided by the GPS unit.

Further features of the present invention, its nature and various advantages will be more apparent from the accompanying drawings and the following detailed description.

### BRIEF DESCRIPTION OF THE DRAWINGS

FIG. 1 is a schematic view of an illustrative electronic device with a Global Positioning System (GPS) unit in accordance with an embodiment of the present invention.

FIG. 2 is a graph illustrating how the temperature of a Global Positioning System (GPS) unit may vary in time as heat-producing functions are performed in accordance with an embodiment of the present invention.

FIG. 3 is a graph illustrating how the error of a Global Positioning System (GPS) unit may be dependent on the temperature of the GPS unit in accordance with an embodiment of the present invention.

FIG. 4 is a graph showing how a temperature-gradient-inducing activity level of an electronic device may vary in time in accordance with an embodiment of the present invention.

FIG. 5 is a graph showing how a Global Positioning System (GPS) sample may be acquired a brief period of time after an initiation of a heat-producing task in accordance with an embodiment of the present invention.

FIG. 6 is a graph showing how Global Positioning System (GPS) samples may be buffered and how the most recent GPS sample that is sampled before an initiation of a heat-producing task can be selected as an associated GPS sample in accordance with an embodiment of the present invention.

FIG. 7 is a graph showing how Global Positioning System (GPS) samples may be acquired after an initiation of a heat-producing task but before the heat-producing task starts producing heat in accordance with an embodiment of the present invention.

FIG. 8 is a graph showing how Global Positioning System (GPS) samples may be acquired after a half-press of a shutter button but before a full-press of the shutter button in accordance with an embodiment of the present invention.

FIG. 9 is a graph showing how an extrapolated Global Positioning System (GPS) sample can be obtained for a moving user device in accordance with an embodiment of the present invention.

FIG. 10 is a graph showing how a Global Positioning System (GPS) service may be temporarily suspended when a user decides to run an application that generates excess heat in accordance with an embodiment of the present invention.

FIGS. 11-16 are flow charts that show illustrative steps involved in acquiring a Global Positioning System (GPS) sample of the type described in connection with FIGS. 6-10 respectively in accordance with an embodiment of the present invention.

### DETAILED DESCRIPTION

This relates to techniques that can be used to reduce Global Positioning System (GPS) errors in electronic devices. Electronic devices such as portable electronic devices and other electronic equipment may provide GPS services. For example, cellular telephones and portable computers may contain GPS circuitry. Electronic devices of this type may provide a user with reliable positioning, navigation, and timing services, for example. These GPS-based services may be used in navigation applications, games, applications with maps and other location-based settings.

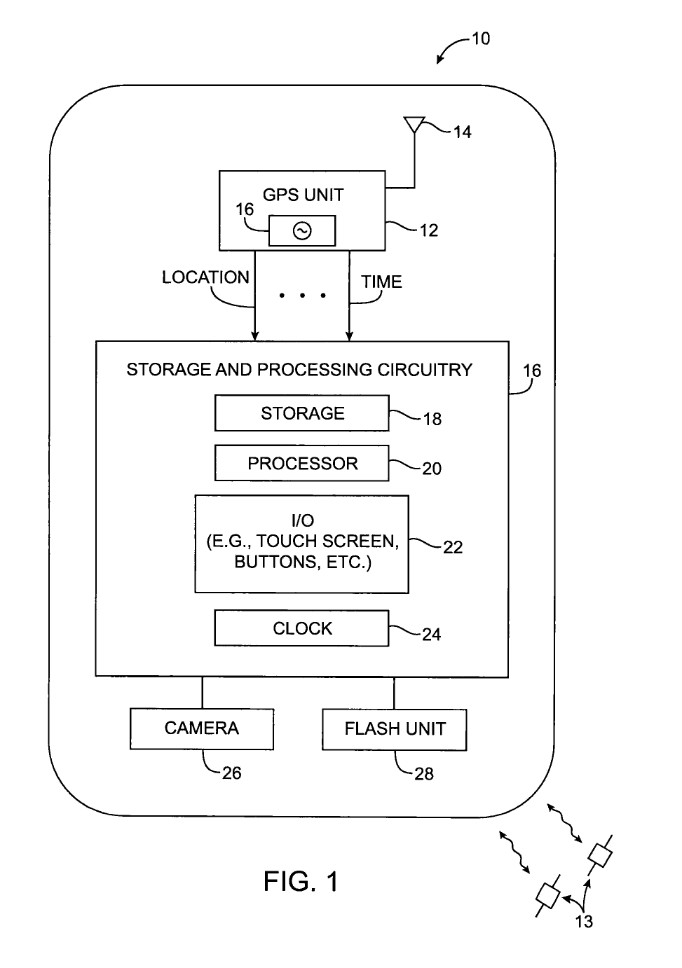

The Global Positioning System includes satellites that orbit the Earth, control and monitoring stations, and GPS receivers that are located within the housing of user devices. There may be at least 20 GPS satellites that orbit the Earth and at least 2 control and monitoring stations located on the surface of the Earth, for example. GPS satellites 13 are shown in FIG. 1.

FIG. 1 also shows an electronic device such as user device 10. User device 10 may provide GPS services. User device 10 may include a GPS receiver such as GPS unit 12. GPS unit 12 may be used to provide GPS location data for the GPS services. GPS unit 12 may have an antenna such as antenna 14. Antenna 14 may receive wireless GPS signals. In particular, antenna 14 may receive GPS signals from GPS satellites 13 as satellites 13 orbit the Earth. GPS unit 12 may have an oscillator such as crystal oscillator 16. Crystal oscillator 16 may provide a highly stable local clock that is used as a reference clock signal.

GPS unit 12 may use clock 16 to calculate its position by precisely timing the signals that are being transmitted by the GPS satellites. For example, each GPS satellite 13 may continuously broadcast signals to GPS unit 12. The broadcasted signals may include information such as the time the signals were sent, relevant orbital information (e.g., the precise location of each satellite), and other related information.

GPS unit 12 may receive the broadcasted GPS satellite information. GPS unit 12 may analyze the times at which the signals are received. The GPS unit may rely on crystal oscillator (local clock) 16 to make precise timing measurements on received signals. GPS unit 12 may calculate the transit time for each received signal based on these timing measurements. The transit time of each message may be multiplied by the speed of light (e.g., the speed at which wireless signals propagate through space) to compute the distance between user device 10 and each corresponding GPS satellite.

Geometric trilateration techniques may then be used to combine the computed distances with the GPS satellites' current locations to determine the position (location) of GPS unit 12. The accuracy of the position obtained by GPS unit 12 is strongly dependent on the accuracy of crystal oscillator 16. Even a small clock error in oscillator 16 may not be acceptable if precise GPS location data is desired. Small clock errors may be magnified when multiplied by the speed of light (e.g., a very large number), resulting in a large positional error. The accuracy of crystal oscillator 16 is generally acceptable during normal operating conditions (e.g., when device 10 is not running processor-intensive applications and is not using heat-producing components). In the presence of heat-inducing activities, however, the possibility of error in GPS location data from unit 12 may arise.

GPS unit 12 may feed GPS data to storage and processing circuitry 16. The GPS data may include information about the current location (e.g., the latitude and longitude) of user device 10. GPS unit 12 may also be used to obtain other useful location information. GPS unit 12 may, for example be able to determine the altitude, direction, and speed of user device 10.

Storage and processing circuitry 16 may include storage circuitry such as storage circuitry 18 (e.g., memory), processing circuitry such as processor 20, input-output (I/O) components such as I/O components 22, and a clock such as clock 24. Storage circuitry 18 may include random-access memory, read-only memory, hard disk drive storage, or other storage devices that are used to store the GPS data. Processor 20 may be used to control the operation of user device 10. Examples of circuits that may be used to implement processor 20 include microprocessors, baseband processors, digital signal processors, microcontrollers, application-specific integrated circuits, etc.

Input-output components 22 may provide an interface through which a user can control device 10. For example, I/O components 22 may include a touch screen, physical buttons, a microphone, a speaker, etc. A user may apply pressure to a touch screen or physical buttons to control the various functions provided by device 10. Voice control and other control techniques may also be used.

Clock 24 may be used to provide additional timing features. For example, clock 24 may be used to determine the frequency at which the GPS data is being stored (sampled) by storage and processing circuitry 16. If desired, clock 24 and clock 16 may be devised from separate oscillating crystals (as an example).

User device 10 may be used for a variety of functions. For example, user device 10 may provide photographic functions. User device 10 may have a camera such as camera 26 installed in the housing of the device. Camera 26 may be used to take pictures (e.g., still images). Camera 26 may also be used to record videos or movies. Camera 26 may take a picture when a user presses a shutter button 22 on device 10, for example. Button 22 may be a virtual button on a touch screen or a physical button.

When pressed, the shutter button triggers operation of a mechanical and/or electronic camera shutter. Camera 26 may have image sensors that are located below a lens. The image sensors may be used to capture images. The image sensors may be exposed to light for a brief period time during which the camera shutter is open. The camera shutter closes after the exposure time expires, and a picture is taken.

User device 10 may include a flash unit such as flash unit 28. Flash unit 28 may be a device that is used to produce an instantaneous flash of artificial light (e.g., strobe light) to help illuminate a scene during image capture. Flash is often required in scenes that do not have adequate natural lighting. Flash unit 28 may be synchronized with camera 26. For example, when a user presses the shutter button, the camera shutter opens. The pressing of the shutter button may also direct flash unit 28 to generate a flash of light that illuminates a scene during the time when the camera shutter is open. Taking a picture is merely an illustrative example. User device 10 may perform other tasks using other components, if desired.

The schematic view of user device 10 shown in FIG. 1 is merely illustrative. Additional circuitry may be used within device 10 to provide additional desired functionality.

The temperature of GPS unit 12 may vary depending on the current operating conditions of device 10. If GPS unit 12 is powered on and if device 10 is not running any processor-intensive applications, the temperature of the GPS unit may be relatively constant around a base temperature TEMP_BASE. A user may wish to perform certain tasks that cause internal device circuitry (e.g., storage and processing circuitry 16, flash unit 28, etc.) to generate additional heat. For example, a user may want to take a picture with flash enabled, start a gaming application, launch a web browser, etc. Different tasks may vary in processing intensity and may cause the peripheral circuitry to generate different heat profiles.

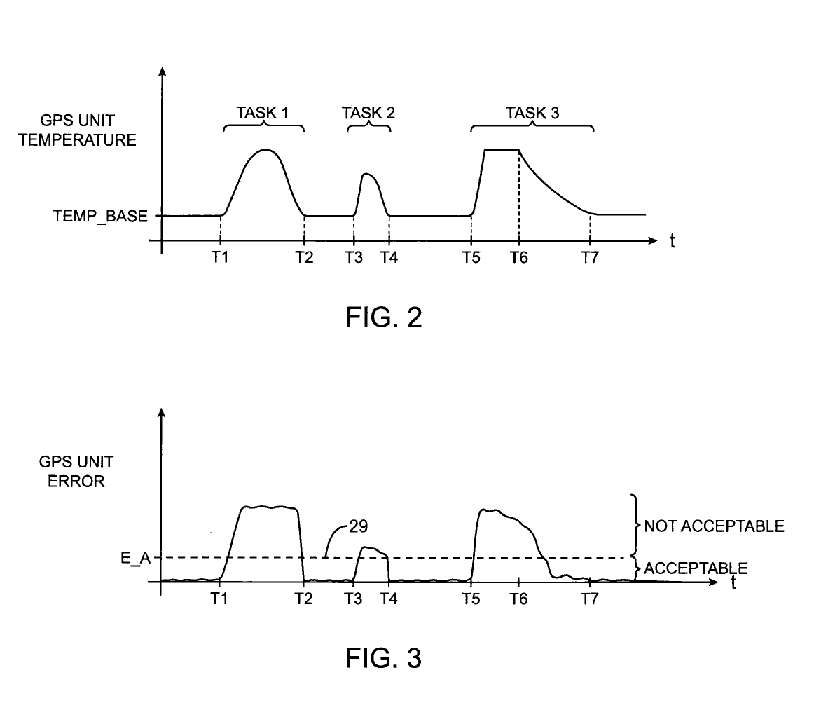

For example, FIG. 2 shows three distinct heat profiles that are generated by three different tasks (e.g., TASK1, TASK2, and TASK3). From time T1 to T2, a user may be using camera 26 to take a picture, thereby triggering flash 28 to cause a spike in the temperature of GPS unit 12 (TASK1). From time T3 to T4, the user may be checking an electronic mail (e-mail) via an e-mail client running on device 10 (TASK2). From time T5 to T6, the user may be on a telephone call with a friend (TASK3).

The temperature gradient (e.g., the instantaneous slope of the heat profiles) may vary from task to task. For example, the temperature gradient at the onset of TASK1 (i.e., immediately after T1) is lower than the temperature gradient at the onset of TASK3 (i.e., immediately after T5). However, the temperature gradient at the end of TASK3 (i.e., from T6 to T7) may be lower than the temperature gradient at the end of TASK1 (i.e., immediately before T2), indicating that TASK3 dissipates heat at a slower rate (possibly because more circuitry is running and therefore more board locations experience heat gains during TASK3). GPS unit 12 will generally function properly as long as the temperature of unit 12 does not change too rapidly. FIG. 3 is a graph showing how an error in the output of GPS unit 12 may vary as a function of time. The GPS data errors may be dependent on the rate of change of the temperature profile of GPS unit (see, e.g., the rate of change of the temperature plotted in FIG. 2). The GPS unit error may track the temperature profile of GPS unit 12. There may be essentially no error when the temperature of GPS unit 12 is at TEMP_BASE. The GPS unit error may be reduced if the instantaneous temperature gradient (e.g. the rate of change in temperature) is low, as shown in the time period from T6 to T7. In other words, GPS unit 12 may be able to tolerate slower changes in temperature even if the absolute GPS unit temperature is at a relatively high level.

There may be a maximum acceptable error level such as acceptable error level E_A. The maximum acceptable error level is indicated by line 29 in FIG. 3. Error levels below E_A (e.g., below line 29) may be deemed to be acceptable by a system designer. Error levels above E_A may be considered not to be acceptable. GPS unit 12 operating at acceptable error levels may provide reasonably accurate GPS location information while GPS unit 12 operating at unacceptable error levels may provide inaccurate GPS location information. For example, an acceptable error level may result in a 5% deviation in accuracy of the GPS location information. If desired, any reasonable maximum acceptable error level may be implemented.

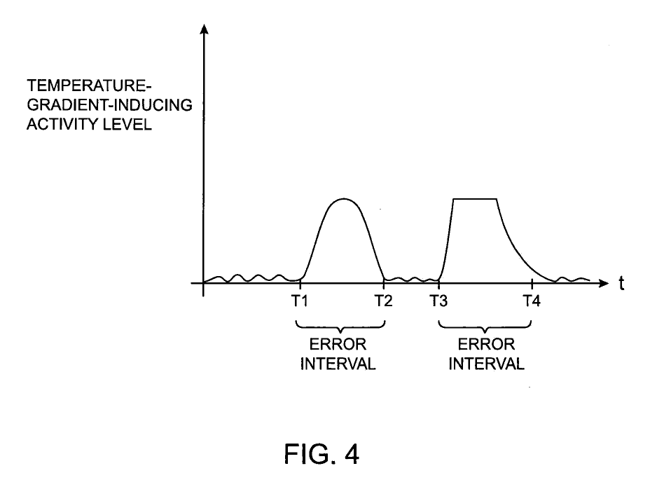

The rise (and subsequent fall) in GPS unit temperature and the corresponding elevation in the rate of change of the temperature of the GPS unit may be a result of running programs or performing other tasks that have high temperature-gradient-inducing activity levels. The temperature-gradient-inducing activity level of a task may reflect a certain task's ability to create sudden changes in temperature. In general, a higher temperature-gradient-inducing activity level results in reduced GPS accuracy. It may therefore be desirable to discard or ignore data generated by GPS unit 12 during periods of elevated activity levels (e.g., error intervals). For example, it may not be desirable for storage and processing circuitry 16 to store the GPS data provided by GPS unit 12 during the error intervals (e.g., periods of potential GPS error such as from time T1 to T2 and from time T3 to T4 of FIG. 4). Operation of GPS unit 12 may be temporarily suspended during the error intervals, if desired.

It may be desirable, however, for GPS unit 12 to produce accurate results that are associated with high activity level tasks. Consider, as an example, a first scenario in which a user wants to take a picture. The user may want to tag the picture with a location tag. Location tagging requires that GPS unit 12 determines the location of device 10 with reasonable accuracy while the picture is being taken. When the user presses shutter button 22 to take the picture, flash unit 28 may be triggered to generate a flash. The flash may give rise to heat that temporarily causes GPS unit 12 provide inaccurate location information (e.g., because the rate of change in the temperature of the GPS unit exceeds a level that is large enough to decrease accuracy below an acceptable level).

Consider, as another example, a second scenario in which a user wants to run a friend finder application. The friend finder application is a location-based service. Proper functionality of the friend finder application therefore requires accurate readings from GPS unit 12. The friend finder application may also require a considerable amount of processing power. The friend finder application may perform certain tasks that have high temperature-gradient-inducing activity levels. As a result, during actual operation of the friend finder application, excess heat generated by processor 20 may cause GPS unit 12 to temporarily provide inaccurate information. As a result, the user may not be able to locate his friend with reasonable accuracy.

The first and second scenarios are merely examples. There may be many other scenarios in which it may be desirable to have GPS unit 12 provide reliable and accurate information that are associated with tasks that have high activity levels. Even though the data provided by GPS unit 12 is not reliable for a brief period of time (e.g., during the error interval) when a task is actually it will generally be possible to compensate for temperature-induced GPS errors and to obtain location-based results with reasonable accuracy (e.g., taking a picture and accurately location tagging the picture). The goal is to acquire an associated GPS data sample that is associated with certain high activity level tasks including tasks such as image acquisition tasks that use flash and which therefore produce heat.

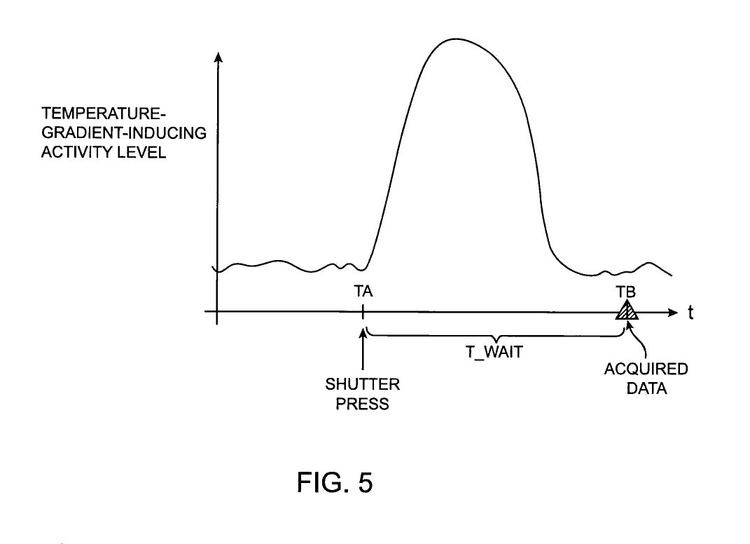

FIGS. 5-9 illustrate various techniques that may be used to accurately perform location tagging when a picture is being taken. The techniques described herein may be used in any situation that involves tasks with high activity levels and tasks that require associated GPS data samples.

FIG. 5 shows a first technique that may be used to acquire reasonably accurate associated GPS data samples. A user may initiate a high activity level task by pressing shutter button 22 at time TA. From time TA to TB, flash unit 12 may generate a flash that causes the temperature-gradient-inducing activity level to spike. During this time, GPS unit 12 may be temporarily suspended or put on hold. GPS unit 12 may wait for duration T_WAIT before resuming operation.

Time T_WAIT may be chosen to be sufficiently long that the activity level will have died down before GPS unit 12 resumes operation. In other words, it may be desirable to wait for the heat to dissipate sufficiently so that the rate of change in the temperature of the GPS unit and therefore the associated error level in the GPS unit decreases to an acceptable level. By waiting a time equal to T_WAIT, the rate of temperature change in the GPS unit will drop sufficiently to increase the accuracy of the GPS unit to an acceptable level (i.e., so that error is less than the maximum acceptable level E_A). This allows GPS unit 12 to provide sufficiently accurate GPS data. The duration of T_WAIT may be controlled by clock 24. T_WAIT may correspond to the duration of the error interval described in connection with FIG. 4. T_WAIT may vary depending on the task at hand. The length of T_WAIT may be predetermined if the task is expected to only last for a certain period of time (e.g., as in the case of a flash). The length of T_WAIT may also be random and may depend on how long a user wishes to run a certain application (e.g., as in the case of a telephone call).

After holding for T_WAIT, GPS unit 12 may resume operation at time TB. The activity level at TB may have returned to a normal level. GPS unit 12 may therefore provide GPS data to storage and processing circuitry 16 at time TB. Storage and processing circuitry 16 may store the sampled data provided by GPS unit 12 at time TB. The data sample acquired at time TB will, in this example, be reasonably accurate. The acquired data sample may be used as the associated GPS data sample. The acquired data sample may include information on the location of device 10 that can be used to location tag the picture. In summary, the first technique acquires the first data point that is obtained after the task has terminated (e.g., after waiting for T_WAIT).

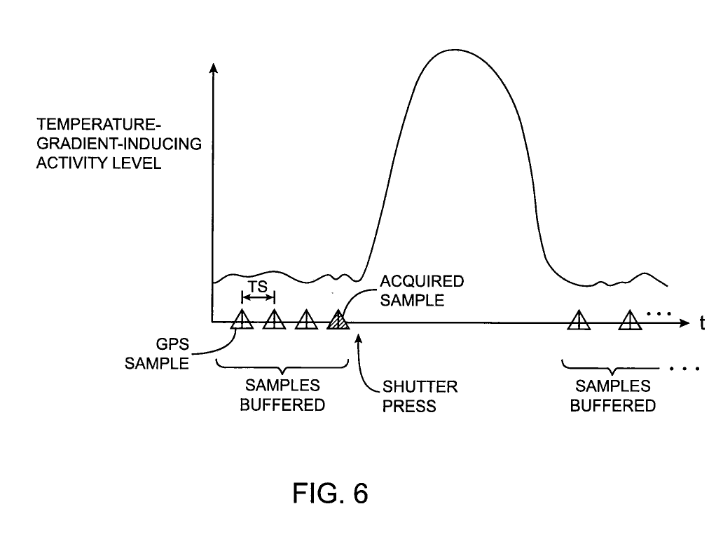

FIG. 6 shows a second technique that may be used to acquire accurate associated GPS data samples. Storage and processing circuitry 16 may sample and store data provided by GPS unit 12 at regular time intervals. For example, each GPS sample stored by storage and processing circuitry 16 may be time TS apart. TS may be 3 seconds long, for example. TS may be any desired duration. A lower TS value results in GPS data being sampled at a higher frequency. In general, a lower TS may provide higher resolution and more accurate data at the cost of power. The GPS samples may be taken at a sampling frequency that is an integer multiple of the frequency of clock 24. The GPS samples may be buffered by storage element 18.

When a user initiates a high activity level task (e.g., by pressing shutter button 22), storage and processing circuitry 16 may select the most recent buffered sample as an acquired sample. The acquired sample may be used as the associated data sample. For example, the acquired sample may contain information that may be used to location tag the picture. GPS unit 12 may be temporarily suspended during the duration of the task (as shown). If desired, GPS unit 12 may not have to be put on hold, and the GPS samples obtained during the duration of the task may be discarded or ignored. In summary, the second technique tags the most recent buffered data that was sampled prior to the start of the task.

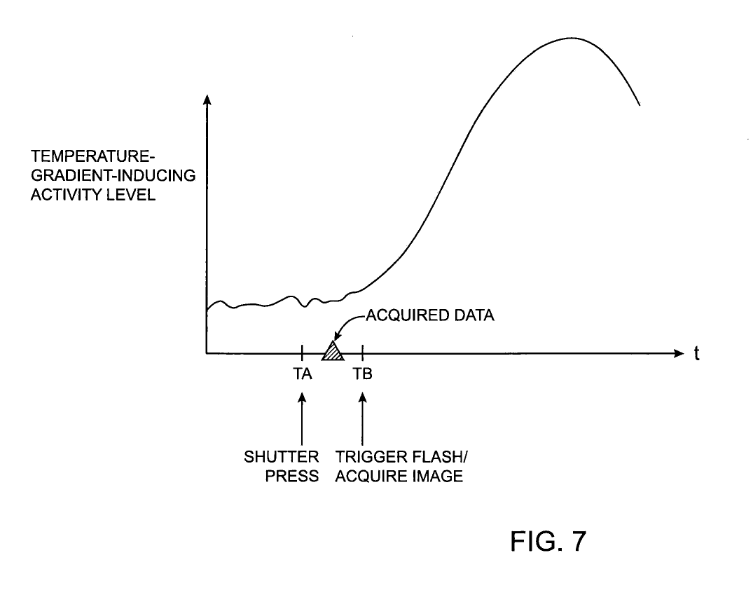

FIG. 7 shows a third technique that can be used to obtain accurate associated GPS data samples in device 10. In contrast to the first and second techniques, the third technique involves acquiring a GPS sample immediately after the user initiates a task. When a user initiates a high activity level task (e.g., by pressing shutter button 22 at time TA), storage and processing circuitry 16 may immediately acquire the next data point generated by GPS unit 12. GPS unit 12 may always be active. The shutter press at time TA may trigger flash unit 28 to generate a flash at time TB. The temperature-gradient-inducing activity level may spike after TB. The key to the third technique is for associated GPS data to be acquired after the initiation of the task, but before the activity level elevating event occurs (e.g., the GPS data sample should be stored sometime between TA and TB).

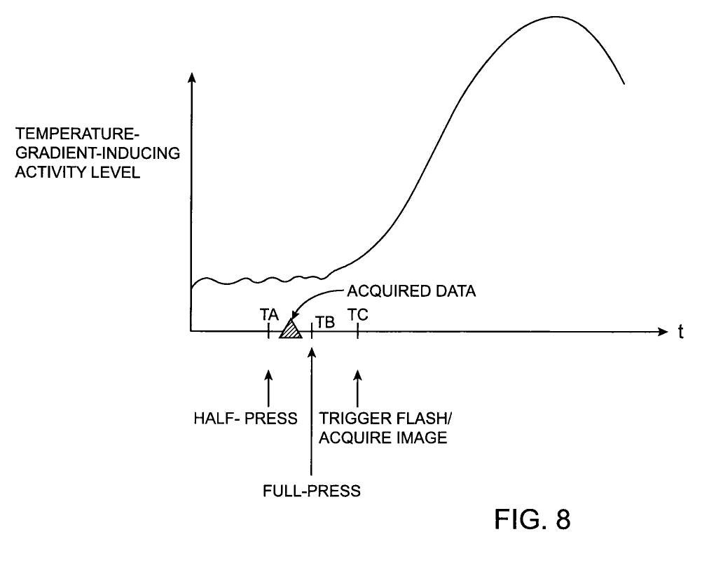

A fourth technique that is shown in FIG. 8 may be used in a scenario in which a half-press of a shutter button (e.g., a mechanical button) is used to take a picture. A half-press process involves 3 steps. First, a user may point camera 26 at a target and half-press button 22 at time TA. Half-pressing allows camera 26 to perform a focus lock. Second, the user may take time to adjust the aim of the picture while maintaining the button in its partially depressed (half-pressed state). Third, the user may take the picture by pressing down button 22 completely (e.g., full-press) at time TB. Similar to FIG. 7, the flash may be triggered at a time after TB (i.e., at time TC). As with the third technique, the key to the fourth technique is that the associated GPS data sample be acquired after the initiation of the task (e.g., immediately after the half-press operation) but before the activity level elevating event occurs (e.g., before the flash is triggered). In other words, the associated GPS data sample should be acquired or stored sometime between TA and TC.

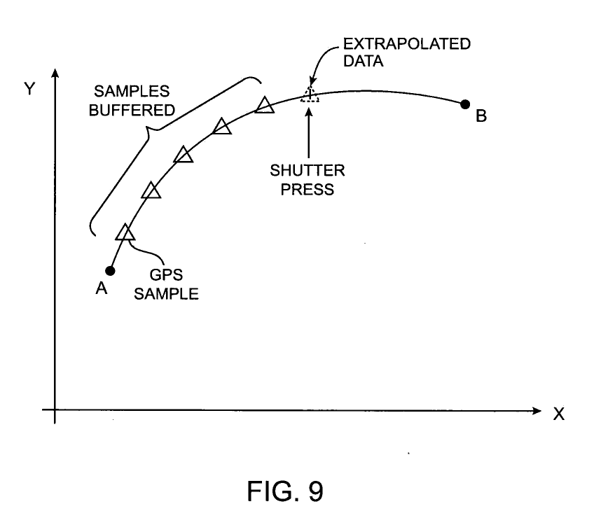

The techniques described in connection with FIGS. 5-8 may be suitable for a user device that is currently stationary. In contrast, a fifth technique may be used to obtain accurate associated GPS data samples for a user device that is moving. FIG. 9 shows a top view of a plane across which a user device is traversing. User device 10 may be moving in a trajectory from point A to point B (e.g., when a user is operating device 10 in a moving vehicle).

The fifth technique may be a modified version of the second technique. As with the second technique, the GPS samples are buffered by storage element 18. The GPS samples may be taken at regular time intervals that are TS apart in time. When a user initiates a high activity level task (e.g., by pressing shutter button 22), storage and processing circuitry 16 may calculate an extrapolated data sample based on the buffered samples (rather than using the last buffered entry). The extrapolated data sample may reflect fairly accurately the location of user device 10 when the shutter press occurred even if user device 10 is moving.

For example, consider a scenario in which user device 10 is traveling in a car at 5 meters per second (mps). The car may be traveling north in a straight line on a freeway. Storage and processing circuitry 16 may be buffering GPS samples every 3 seconds. A user may use device 10 to take a picture while the car is moving. The user may press shutter button 22 two seconds after the previous GPS sample. Because the device is moving, it may not be desirable to use the most recent buffered GPS sample as the associated GPS data sample in this scenario. Processor 20 may include circuitry that can be used to calculate the precise location of device 10 at the exact moment the shutter press occurred.

From the set of buffered GPS data, processor 20 may be able to determine the direction and speed at which device 10 is traveling. Using the most recent GPS sample taken immediately before the shutter press and information about the direction and speed of the device, it may be possible to determine the desired location of the device. In this case, device 10 would be 10 meters (e.g., 2 seconds multiplied by 5 mps) north of the most recent GPS sample. This calculated location may then be used as the associated GPS data sample. This example is merely illustrative. The same method may be used to determine associated GPS data samples for devices that are traveling in a curved path at any speed, devices that are accelerating or changing altitude, etc.

Not every task requires an associated GPS data sample. A user may want to initiate a task that does not require any GPS data. Consider a scenario in which a user is initially using device 10 as a GPS navigator (e.g., device 10 is displaying a map with a moving cursor that indicates the position of the device in real time). Storage and processing circuitry 16 may be recording GPS samples at regular time intervals (e.g., every 3 seconds) during normal operations. The time interval may be any duration of time.

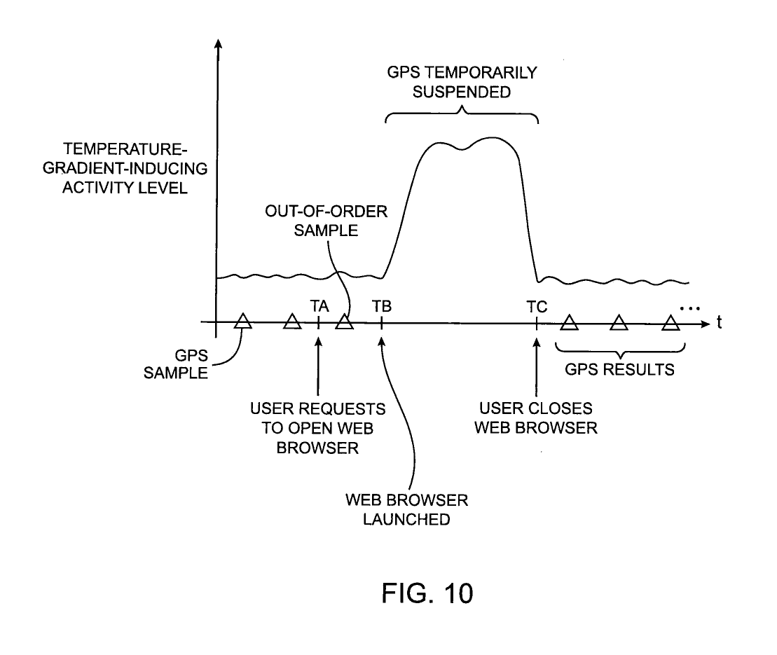

A user may want to interrupt the GPS navigation application to open a web browser to browse the Internet, as illustrated in FIG. 10. At time TA, the user may press a button on the touch screen of device 10 to indicate that he wants to open a web browser. The web browser may not be immediately launched. Storage and processing circuitry 16 may acquire an out-of-order sample at a time after time TA. The out-of-order sample will be stored as the most recent location of the device 10.

At some time after the out-of-order sample is acquired, device 10 may launch the web browser at time TB. The temperature-gradient-inducing activity level may be high for a period of time after TB. The activity level may remain high until the user decides to close the web browser at time TC. GPS unit 12 may be temporarily suspended from time TB to TC, as shown in FIG. 10. If desired, GPS unit 12 may not be suspended from time TB to TC. Rather, storage and processing circuitry 16 may simply ignore or discard the data generate by GPS unit 12 during this time period. After the user closes the web browser at time TC, GPS unit 12 resumes its normal operation. The first reference location that GPS unit 12 uses immediately after time TC may be the most recent out-of-order sample. Thereafter, the most current location of device 10 will be determined as new GPS samples are taken after time TC.

The example shown in FIG. 10 is merely illustrative. This scheme may be applicable to any application or process that may temporarily affect the GPS capabilities of a user device.

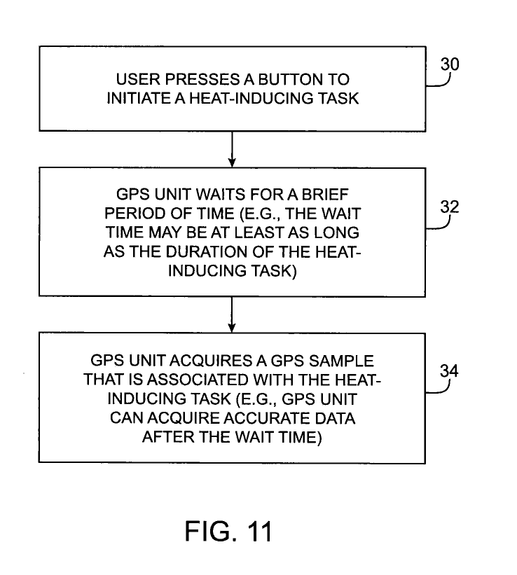

FIG. 11 shows the illustrative steps involved in acquire a GPS sample of the type described in connection with FIG. 5. At step 30, a user may press a button (e.g., a virtual and/or mechanical shutter button) to initiate a heat-inducing task (e.g., a task having high temperature-gradient-inducing activity levels). GPS unit 12 may wait for a brief period of time T_WAIT (step 32). The duration of time T_WAIT may be at least as long as the duration of the heat-inducing task. During the wait period, GPS unit 12 may not be able to produce accurate data. After the wait period, however, GPS unit 12 may be able to produce accurate location data, because the heat generate by the task has subsided. At step 34 (i.e., immediate after T_WAIT expires), GPS unit 12 may acquire an associated GPS sample.

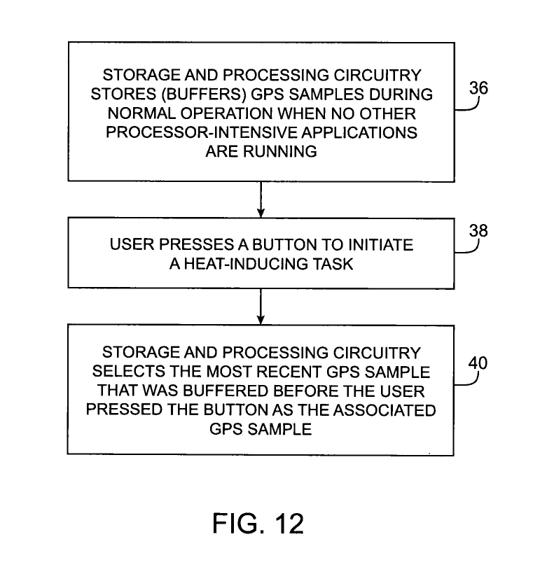

Alternatively, FIG. 12 shows the steps used in another technique that involves storing (buffering) GPS samples, as described in connection with FIG. 6. At step 36, storage and processing circuitry stores (buffers) GPS samples during normal operation when no other processor-intensive applications are active. At any time, a user may press a button to initiate a heat-inducing task (step 38). At step 40, the storage and processing circuitry may select the most recent GPS sample that was buffered prior to the button press as the associated GPS sample.

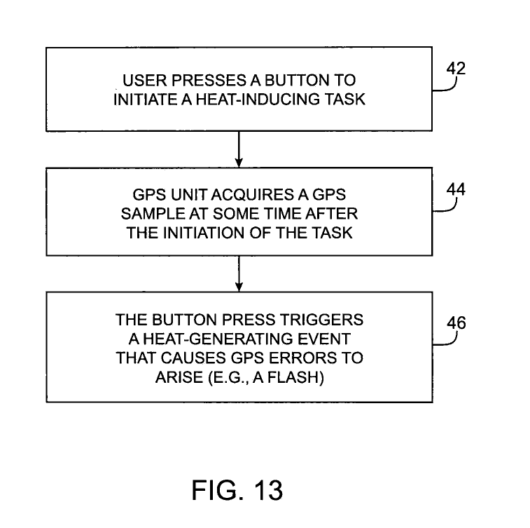

Alternatively, FIG. 13 shows the steps used in another technique that involves acquiring a GPS before GPS unit 12 starts producing erroneous data, as described in connection with FIG. 7. At step 42, a user may press a button to initiate a heat-inducing task. Some time after the button press, GPS unit 12 may acquire a GPS sample (step 44). After the GPS sample is acquired, a heat-generating event may be triggered that causes GPS errors to arise (step 46). For this technique to work, step 44 must occur before step 44. In other words, the GPS sample must be acquired before GPS unit starts generating erroneous data (e.g., before high temperature-gradient-inducing activity level starts to increase).

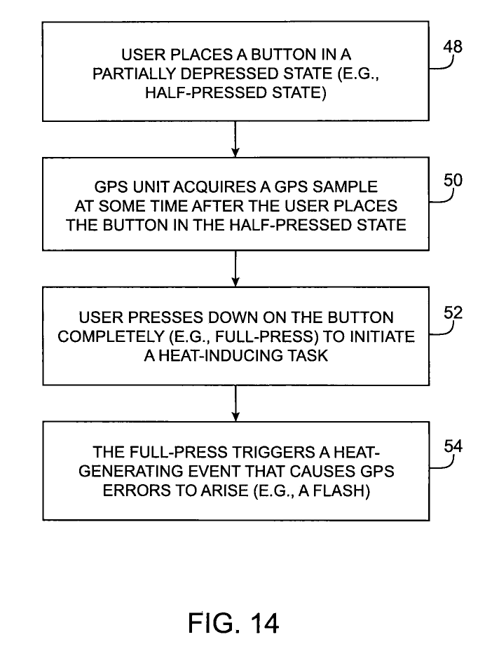

Alternatively, FIG. 14 shows the steps involved in acquiring a GPS sample after partially depressing a shutter button, as described in connection with FIG. 8. At step 48, a user may place a button (e.g., a mechanical shutter button) in a partially depressed state (e.g., a half-pressed state). At some time while the button is in the partially depressed state, GPS unit 12 may acquire a GPS sample (step 50). At step 52, the user may press down on the button completely (e.g., place the button in a full-pressed state) to initiate a heat-inducing task. The full-press may then trigger a heat-generating event that causes GPS errors to arise (step 54). In summary, the associated GPS sample is acquired at some time while the button is in the partially depressed state (after step 48) and is acquired before completely pressing down on the button (before step 52).

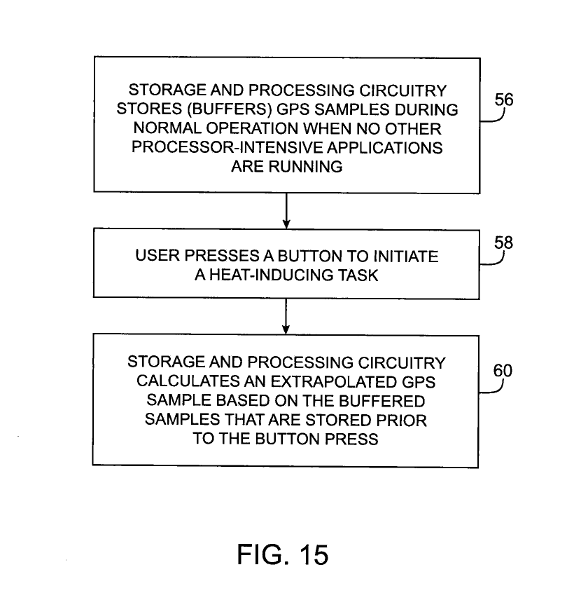

Alternatively, FIG. 15 shows the steps that can be used to acquire a GPS sample for a user device that is moving, as described in connection with FIG. 9. At step 56, storage and processing circuitry may store (buffer) GPS samples during normal operation. At any time, a user may press button 22 to initiate a heat-inducing task (step 50). At step 60, instead of taking the most recent sample, storage and processing circuitry may calculate an extrapolated GPS sample based on the buffered samples taken immediately prior to the button press (e.g., the extrapolated GPS sample may be based on at least two of the most recently buffered samples). Calculating an extrapolated GPS sample in this way may be desirable to acquire associated GPS data for a moving user device.

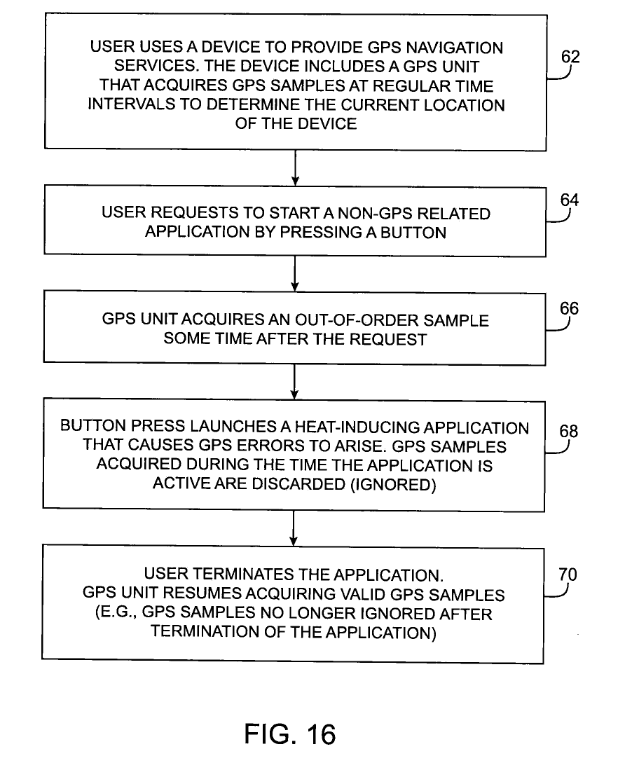

FIG. 16 shows the steps involved in acquiring GPS data in a user device that is currently being used to provide a navigation service, as described in connection with FIG. 10. At step 62, a user may be using a device for its GPS navigation services. The device may include a GPS unit that samples GPS data. The device may display a map with a moving cursor that constantly updates the current location of the user device. At step 64, the user may request to start a non-GPS related application by pressing a button (e.g., open a web browser, start a gaming application, etc.). At some time after the button press, GPS unit may acquire an out-of-order sample (step 66). At step 68, the device launches the requested heat-inducing application that causes GPS errors to arise. The GPS samples acquired during the time the heat-inducing application is running may be discarded (ignored), because the samples may be inaccurate. In other words, the navigation service is temporarily put on hold during the duration of the non-GPS related, heat-inducing application. At step 70, the user may terminate the application. Upon termination, the GPS unit may resume acquiring valid GPS samples to update the current location of the device (e.g., GPS samples are no longer discarded).

The foregoing is merely illustrative of the principles of this invention and various modifications can be made by those skilled in the art without departing from the scope and spirit of the invention.

What is claimed is:

1. A method for tagging images with location data in a portable electronic device, comprising:
detecting a user command to acquire an image with the portable electronic device;
in response to detection of the user command, obtaining a location data sample indicating where the portable electronic device is currently located using the portable electronic device;
after obtaining the location data sample, acquiring an image with the portable electronic device; and
tagging the image that has been acquired with the location data sample.

2. The method defined in claim 1, wherein acquiring the image with the portable electronic device comprises storing the location data sample with storage and processing circuitry in the portable electronic device.

3. The method defined in claim 1, wherein obtaining the location data sample comprises using a Global Positioning System unit to provide location-based information.

4. The method defined in claim 3, wherein obtaining the location data sample further comprises operating the Global Position System unit to produce sufficiently accurate location-based information at an acceptable error level that is lower than a maximum acceptable error level.

5. The method defined in claim 4, wherein acquiring the image with the portable electronic device comprises producing a flash of light with a flash unit in the electronic device after obtaining the location data sample.

6. The method defined in claim 5, wherein producing the flash of light with the flash unit in the electronic device comprises generating heat that increases error in the location-based information to an unacceptable error level that is greater than the maximum acceptable error level.

7. The method defined in claim 1, wherein detecting the user command comprises detecting a button press.

8. A method of operating an electronic device of a user that has a Global Positioning System unit, comprising:
in response to input from the user, initiating a task on the electronic device that produces temperature changes at a rate that decreases accuracy in the Global Positioning System unit;
waiting for the rate of temperature changes to drop sufficiently to increase the accuracy of the Global Positioning System unit to an acceptable level; and
after waiting for the rate to drop sufficiently, obtaining a sample from the Global Positioning System unit with storage and processing circuitry in the electronic device.

9. The method defined in claim 8, wherein the input from the user comprises a button press, the method further comprising:
initiating the task in response to detecting the button press.

10. The method defined in claim 9, wherein initiating the task comprises producing a flash of light with a flash unit in the electronic device in response to the button press.

11. The method defined in claim 9, further comprising:
with the storage and processing circuitry, storing the sample that was obtained from the Global Positioning System unit.

12. A method of operating a user device having a Global Positioning System unit, comprising:
with storage and processing circuitry in the user device, storing Global Positioning System samples during normal operation of the user device when no heat-inducing tasks are being performed;
detecting a user command with the storage and processing circuitry that initiates a heat-inducing task associated with a rate of temperature change that increases an error level in the Global Positioning System unit above an acceptable error level; and
in response to detecting the user command, using the storage and processing circuitry to select one of the Global Positioning System samples that was stored prior to the user command to use in association with the heat-inducing task.

13. The method defined in claim 12 wherein storing the Global Positioning System samples comprises:
using the storage and processing circuitry to buffer the Global Positioning System samples at regular time intervals during normal operation.

14. The method defined in claim 13, wherein the heat-inducing task involves producing a flash of light while acquiring an image, the method further comprising using the storage and processing circuitry to location tag the image with the selected one of the Global Positioning System samples.

15. A method of operating an electronic device of a user that has a Global Positioning System unit, comprising:
with storage and processing circuitry in the electronic device, detecting an input from the user that directs the electronic device to perform an operation, wherein the operation produces heat, wherein during an error interval resulting temperature changes are sufficiently rapid to cause the Global Positioning System unit to produce location data with more than a given amount of error; and
in response to detecting the input from the user, using the storage and processing circuitry to obtain location data from the Global Positioning System unit immediately after the detection of the input from the user and before the operation that produces heat is performed.

16. The method defined in claim 15, wherein performing the operation that produces heat comprises producing a flash of light with a flash unit in the electronic device.

17. The method defined in claim 15, wherein performing the operation that produces heat comprises running a processor-intensive application on the storage and processing circuitry.

18. The method defined in claim 15, wherein performing the operation that produces heat comprises using wireless communications circuitry in the electronic device.

19. A method of operating a user device having a Global Positioning System unit, comprising:
with storage and processing circuitry in the user device, storing Global Positioning System samples during normal operation of the user device when no heat-inducing tasks are being performed;
detecting a user command with the storage and processing circuitry that initiates an operation in the user device that produces temperature changes at a rate that decreases accuracy of the Global Positioning System unit below an acceptable level; and
in response to detecting the user command, using the storage and processing circuitry to calculate an extrapolated Global Positioning System sample based on the samples that are stored prior to the user command.

20. The method defined in claim 19, wherein the operation comprises producing a flash with a flash unit in the user device to acquire an image, the method further comprising:
tagging the image with the extrapolated Global Positioning System sample.
